(19) United States
(12) Patent Application Publication
(10) Pub. No.: US 2015/0019165 A1
(43) Pub. Date: Jan. 15, 2015

(54) WEIGHT DETECTION BY TIRE PRESSURE SENSING

(71) Applicant: Infineon Technologies AG, Neubiberg (DE)

(72) Inventors: Horst Theuss, Wenzenbach (DE); Johann Mayer, Demling (DE); M.I. Eko Prihantoro, Nittendorf (DE)

(21) Appl. No.: 13/940,586

(22) Filed: Jul. 12, 2013

(51) Int. Cl. G01G 19/08

(52) U.S. Cl. CPC G01G 19/08
USPC 702/173

(57) ABSTRACT

A system includes a set of tire pressure sensors for tires of a vehicle, a control module and a user interface. The control module is configured to receive tire pressure information from the tire pressure sensors and calculate a weight or a change in weight of the vehicle based on the tire pressure information. The user interface configured to present, to a user, an indication of the weight or the change in weight of the vehicle calculated by the control module.

### TECHNICAL FIELD

The invention relates to weight detection of vehicles using vehicle sensors such as tire pressure sensors.

### BACKGROUND

There are a number of reasons why an operator might want to know the weight of their vehicle. For example, knowing the weight of a vehicle may facilitate compliance with governmental vehicle regulations. As another example, knowing the weight of a vehicle may be required to ensure that a vehicle's load does not exceed the rated capacity of the vehicle. As a further example, knowing a change in weight of a vehicle may allow an operator to know the weight of cargo loaded or unloaded from the vehicle.

However, determining the weight of a vehicle is not always convenient. For example, determining the weight of a vehicle generally requires positioning the vehicle on a scale. Dependent on the location of a scale, driving the vehicle to the scale may take a significant amount of time, and the vehicle may not be in safe operating condition during the drive to the scale since the vehicle's weight has not yet been determined. In addition, vehicle scales require significant installation costs, maintenance and can take up a lot of space, including the space required to allow vehicles to enter and exit the scale.

### SUMMARY

In general, this disclosure is directed to weight detection of vehicles using vehicle sensors such as tire pressure sensors. Disclosed techniques include determining a weight of the vehicle or a change in weight of a vehicle according to tire pressure or a change in tire pressure of the vehicle, such as a change in tire pressure from a time prior to the loading or unloading of the vehicle to a time after the loading or unloading of a vehicle. The determined change in weight of the vehicle may then be added or subtracted to a predetermined weight of the vehicle to determine the total weight of the vehicle following the change in weight of the vehicle. In some examples, the techniques may include using additional data, such a tire temperature. Also disclosed are techniques for calibrating calculations for determining a change in weight of a vehicle according to a change in tire pressure to specific tires designs or even to individual tires.

In one example, this disclosure is directed to a system including a set of tire pressure sensors for tires of a vehicle, a control module and a user interface. The control module is configured to receive tire pressure information from the tire pressure sensors and calculate a weight or a change in weight of the vehicle based on the tire pressure information. The user interface configured to present, to a user, an indication of the weight or the change in weight of the vehicle calculated by the control module.

In another example, this disclosure is directed to a method comprising receiving, with a control module, an indication of a first set of tire pressure information from one or more tire pressure sensors of a vehicle. The method further includes receiving, with the control module, an indication of a second set of tire pressure information from the one or more tire pressure sensors of the vehicle, and calculating, with the control module, a weight of the vehicle or a change in weight of the vehicle based on the first set of tire pressure information and the second set of tire pressure information. The method also includes presenting, with the control module, an indication of the weight of the vehicle or the change in weight of the vehicle to a user via a user interface.

The details of one or more examples are set forth in the accompanying drawings and the description below. Other features, objects, and advantages of this disclosure will be apparent from the description and the figures, and from the claims.

### BRIEF DESCRIPTION OF DRAWINGS

FIG. 1 illustrates a system for determining a weight of a vehicle or a change in weight of the vehicle based on detected tire pressures in the tires of the vehicle.

FIG. 2 illustrates an example calibration curve showing load corresponding to a detected pressure of a tire.

FIG. 3 illustrates a set of calibrations curves for a tire at different initial pressures.

FIG. 4 is a flowchart illustrating example techniques for determining a weight of a vehicle or a change in weight of the vehicle based in detected tire pressures in the tires of the vehicle.

### DETAILED DESCRIPTION

The weight of a vehicle or a change in weight of a vehicle may be detected using information from tire pressure sensors. For example, a change in weight of a vehicle may correlate to a change in tire pressure of the vehicle, such as a change in tire pressure from a time prior to the loading or unloading of the vehicle to a time after the loading or unloading of a vehicle. The determined change in weight of the vehicle may then be added or subtracted to a predetermined weight of the vehicle to determine the total weight of the vehicle following the change in weight of the vehicle. As another example, detected tire pressure may directly correspond to a total load on each tire. In some examples, the techniques may include using additional data, such a tire temperature. Also disclosed are techniques for selecting calibration curves for determining a change in weight of a vehicle according to a change in tire pressure to specific tires designs or even to individual tires.

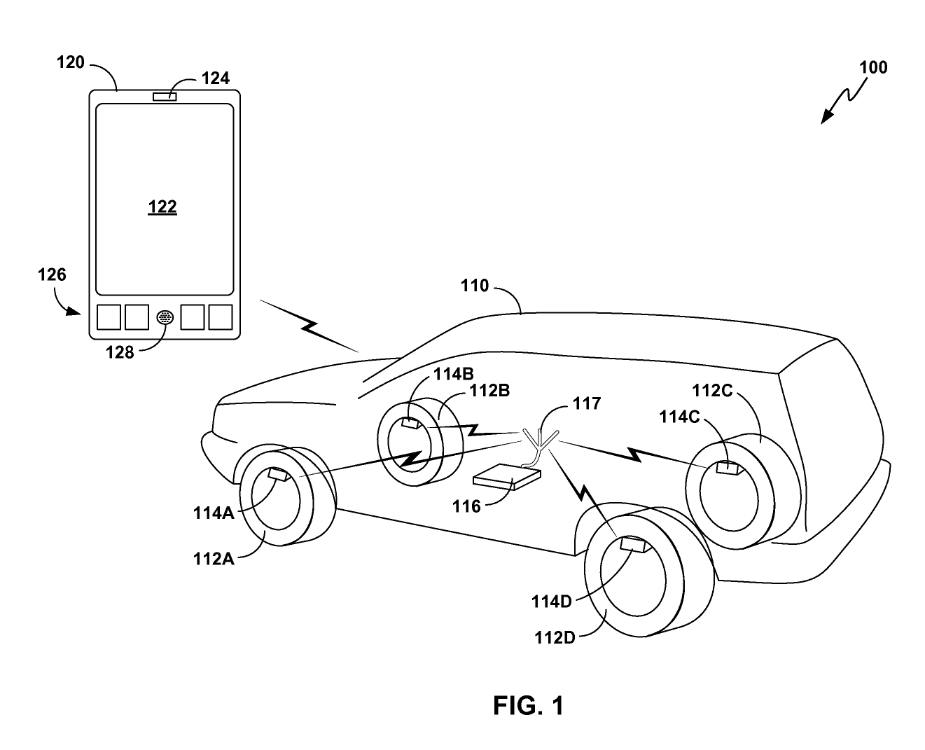

FIG. 1 illustrates an example system 100 for determining a weight of a vehicle based on detected tire pressures in the tires of the vehicle. System 100 includes vehicle 110 and mobile communication device 120. Vehicle 110 may be any type of vehicle, such as, but not limited to, a passenger car, a sport utility vehicle, a van, an agricultural vehicle, or a trailer. Vehicle 110 includes wheels 112A:112D, (collectively “wheels 112”) with respective tire pressure sensors 114A:114D, (collectively “tire pressure sensors 114”). Vehicle 110 also includes an optional control module 116 configured to calculate a weight of vehicle 110 or a change in weight of vehicle 110 in some examples of this disclosure. Control module 116 is located within vehicle 110, and control module 116 is powered by an electrical system of vehicle 110. In the same or other examples, mobile communication device 120 may include software configured to calculate a weight of vehicle 110 or a change in weight of vehicle 110 such that mobile communication device 120 may serve as the control module configured to calculate a weight of vehicle 110 or a change in weight of vehicle 110.

Tire pressure sensors 114 are located in wheels 112 and are configured to measure the tire pressures of the tires of wheels 112. Tire pressure sensors 114 may be located on the valve or on the rim, for example. Tire pressure sensors 114 each include communication modules to facilitate transmission of tire pressure information to a remote device, such as control module 116 and/or mobile communication device 120. In some examples, the communication modules may include wired or wireless transmitters, such that the tire pressure measurements are sent via wire or wirelessly to control module 116, via antenna 117. In other examples, control module 116 may include multiple antennas adjacent to each of tire pressure sensors 114. In other examples, tire pressure measurements may be sent directly via wireless connections to mobile communication device 120. In either case, the control module includes a wireless receiver for receiving the tire pressure information from the pressure sensors 114 via one or more wireless data connections. In some examples, the wireless connections may include Bluetooth, Wi-fi or other short range wireless connections.

Either control module 116, mobile communication device 120, a separate computing device (not shown), or a combination thereof may be utilized as a control module configured to receive tire pressure information from tire pressure sensors 114, and calculate a weight or a change in weight of vehicle 110 based on the tire pressure information. The control module may calculate the weight or the change in weight of vehicle 110 based on tire pressure information from each of tire pressure sensors 114 by accessing an indication of one or more calibration curves modeling weight versus pressure for each of the tires of wheels 112, and calculate the weight or the change in weight of vehicle 110 based on the tire pressure information and further based on the indication of one or more calibration curves.

The control module may further utilize a user interface, such as a user interface including a display and/or speaker, to present an indication of the weight or the change in weight of the vehicle calculated by the control module to a user. In some examples, the user interface may include components of vehicle 110, such as speakers or a dashboard display. In further examples, the user interface may include components of mobile communication device 120 or other external electronic devices. In some examples, the control module may store a record of the change in weight of the vehicle over time on a computer readable medium.

Mobile communication device 120 includes screen 122, which is a touch-sensitive screen capable of receiving user input in some examples, speaker 124, buttons 126 and microphone 128. In some examples, mobile communication device 120 may be a cellular phone, such as a smartphone. In examples in which mobile communication device 120 is included in the control module, mobile communication device 120 may receive user inputs for implementing a weight calculation or a change in weight calculation and/or for selecting calibration curves associated with the tires of wheels 112. In some examples, mobile communication device 120 may receive addition data from a user, such as data reporting the weight of vehicle 110, which may be used to model calibration curves for the tires of wheels 112. Mobile communication device 120 may receive user inputs via screen 122, buttons 126, microphone 128 or a combination thereof.

In examples in which mobile communication device 120 is included in the control module, mobile communication device 120 may also present an indication of a weight or the change in weight of vehicle 110 calculated based on tire pressure information from tire pressure sensors 114 to a user. For example, the indication of the weight or the change in weight of vehicle 110 may be presented to a user via screen 122 and/or speaker 124.

In a basic example, the control module may determine the additional load Δm of a vehicle (mass m₀) as a result of loading cargo by measuring the load-induced increased tire pressure Δp. The measured relative pressure increase Δp/p₀ corresponds to an additional load Δm according to calibration curve, such as a mathematical algorithm or a calibration curve populated according to test data. As referred to herein, the term p₀ denotes the pressure prior to loading of a vehicle.

In the most generic terms the relationship between the additional load Δm of a vehicle and the measured relative pressure increase Δp may be represented according to Equation 1.

Δm=f(p₀, Δp) (Equation 1)

Equation 1 merely represents that the change in load, Δm, supported by a tire is a function of the initial pressure, p₀, of the tire and the change in pressure, Δp of the tire.

This relationship can be approximated such that the change in load, Δm, is proportional the change in pressure, Δp, as shown in Equation 2.

$$Δ m = {m}_{0} * \frac{Δ p}{{p}_{0}} \qquad ( Equation 2 )$$

However, Equation 2 above does not account for potential changes in the contract surface area, A, of a tire and the ground. For example, a larger load may result in tire deformation and a larger contact area, such that Equation 2 may underestimate the increased load. The change in the contract surface area may be accounted for as shown in Equation 3. In Equation 3, A represents the contract surface area of a tire and the ground, whereas g represents gravity.

$$Δ m = ( {m}_{0} - \frac{A}{g} ) * \frac{Δ p}{{p}_{0}} \qquad ( Equation 3 )$$

In some cases, the change in contact surface area due to a change in weight of a vehicle may be insignificant compared to the change in pressure. In such instances, Equation 2 may provide a suitable basis for determining a change in weight versus a change in pressure. However, even in cases in which increased precision than that provided by Equation 2 is desired, it is still possible to determine a change in weight versus a change in pressure without taking any additional measurements. As one example, the area, A, as shown in Equation 3 correlates to detected pressure for any given weight. This means that if m₀ is known, then it is not necessary to separately measure area determine the change in weight of a vehicle.

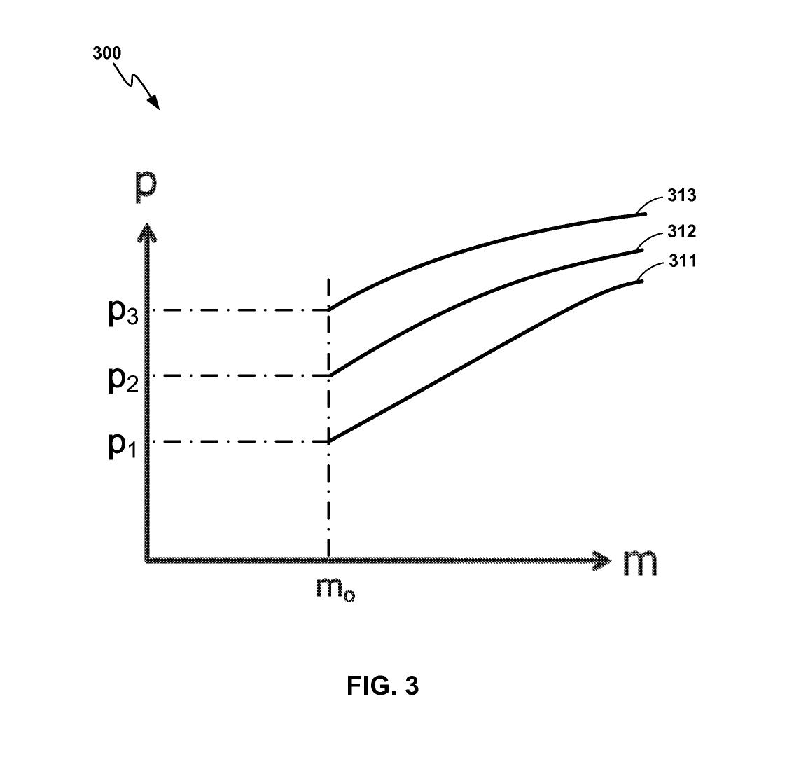

For more accurate weight calculations, the elastic properties of the specific tires on wheels 112 should be considered. Each tire may be associated with a family of calibration curves, e.g., as shown in FIG. 3. Such a family of calibration curves could be supplied by a tire manufacturer. As described in greater detail below, the family of calibration curves for a tire represents the one-to-one relationship between tire pressure and load for any given initial pressure.

While the elastic properties of the specific tires on wheels 112 may vary with temperature, in some examples, temperature dependencies can be neglected as being insignificant. In other examples, temperature information can be included within a family of calibration curves for a tire. For example, vehicle 110 may include one or more thermometers that outputs at least one temperature associated with the tires of wheels 112. In some examples, tire pressure sensors 114 may each include a thermometer. In such examples, the control module may calculate the weight or the change in weight of vehicle 110 based on the tire pressure information includes calculating the weight or the change in weight of the vehicle based on the tire pressure information, on the temperature associated with the tires of the vehicle, and a family of calibration curves associated with that tire, the family of calibration curves defining a one-to-one correlation between loading and pressure of a tire at a given temperature and a given initial pressure.

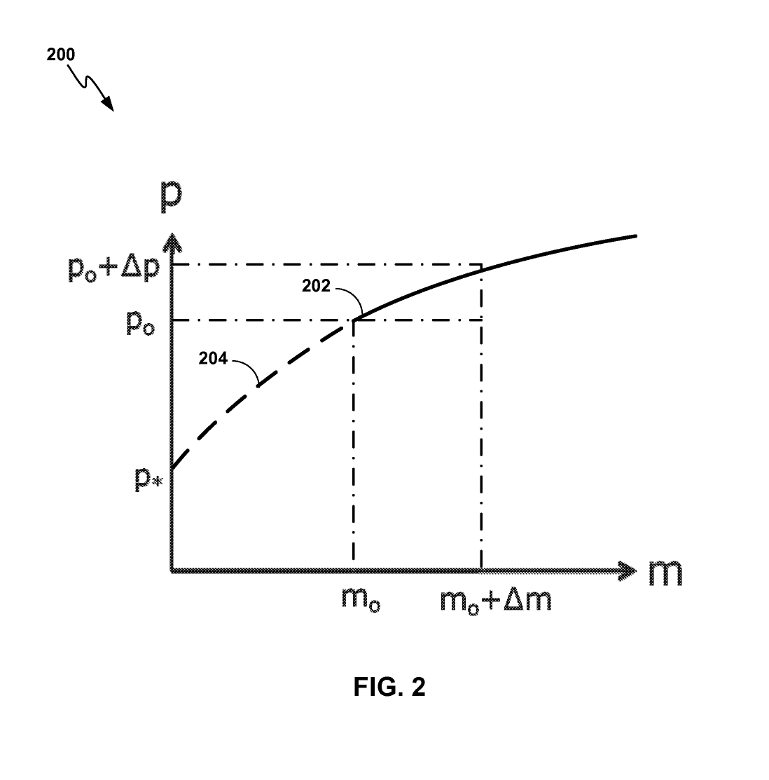

FIG. 2 is a graph 200 that illustrates an example relationship between pressure and load on a tire as calibration curve 202. Calibration curve 202 begins at p₀ and continues through Δp. As represented by calibration curve 202, there is a one-to-one correlation between pressure and mass such that mass, m and change in mass, Δm can be determined based only on pressure. Thus, calibration curve may 202 be utilized by a control module to calculate a weight or a change in weight of the vehicle based on the tire pressure information.

Graph 200 further illustrates a projection 204 for calibration curve 202 at masses of less than m₀. However, represents the load on the tire when the vehicle does not include any cargo. For this reason, the value p* cannot be determined, because it refers to a situation of an inflated tire “without” a car on top of it, that is (m₀=0).

However, it may be advantageous to know m₀ and p₀ as different initial pressures,p₀, will result in different Δp for a given Δm. An example of this relationship is represented by graph 300 of FIG. 3.

Graph 300 illustrates three different calibrations curves 311, 312, 313 for the same tire and the same initial mass, m₀. Calibration curves 311, 312, 313 are each associated with a different initial pressure, respectively labeled as p₁, p₂, and p₃ in graph 300. As represented by graph 300, for any given change in load, Δm, the change in pressure Δp response to the change in load is dependent on the initial pressure. For this reason, in order to precisely determine a change in weight of a vehicle during a loading or unloading operation, it may be useful to have a least a single data point of pressure versus load prior to the change in load. This relationship is represented by Equation 1 above. However, once the single data point of pressure versus load is known, then the proper calibration curve, such as one of calibration curves 311, 312, 313, may be used because there is a one-to-one correlation between pressure and load for any given initial pressure.

In one example, the single data point of pressure versus load may be created by a user entry signifying the current weight of a vehicle. The control module may then use that weight and the current sensed pressure of the tires to select the proper calibration curves for the tires. The user may indicate the current weight based on simply indicating the current loading of the vehicle, e.g., “empty.” In such an example, using the known weight and weight distribution of the empty vehicle, the control module may then select the proper calibration curves for the tires. The control module may instruct the user to be outside the vehicle during the calibration so that the weight of the user does not affect the calibration. The control module may also be located outside the vehicle, such as when control module is mobile communication device 120. Alternately, the user may indicate the current weight of the vehicle based on a measurement from a separate scale. This would allow a user to simply “recalibrate” the control module according to changing initial pressures of the tires at different times. For example, because tire pressure can change due to increases in tire temperature while driving, it may be useful for a user to recalibrate the initial pressure of the tires immediately prior to loading or unloading cargo in to facilitate calculation of the weight of the cargo.

In other examples, the control module may simply use a projected initial pressure of the tires when select the proper calibration curves for the tires. For example, the slope of each of calibration curves 311, 312, 313 is similar such that the control module can correlate a change in pressure to a change in load even if the initial pressure is not known. The control module may further account for a change in measured temperature of the tires to determine the amount of the change in pressure due to a change in load.

The control module may combine the change in loads for each of the tires of a vehicle in order to determine the net change in weight or the net weight of a vehicle. In some examples, the control module may calculate a load balance based on the tire pressure information, and present an indication of the load balance calculated by the control module. For example, the control module may issue a warning to a user via a user interface if a load is improperly distributed within vehicle 110 as indicated by the individual changes in pressure indicated by pressure sensors 114.

In different examples, the calibration curves for a tire may be determined using one or more of the equations above, or the calibrations curves for a tire may be experimentally determined, e.g., to populate a dataset facilitating the determination of load on a tire given a single data point of pressure versus load. Individual tires and tire designs may have unique calibration curves. For this reason, it may be useful for the control module to identify the tires of a vehicle in order to select a proper calibration curve for the tires.

The control module may access an indication of one or more calibration curves, which model weight versus pressure for each of the tires of wheels 112, by accessing a data storage device that stores information that identifies the one or more calibration curves modeling weight versus pressure for the tires of the vehicle. In different examples, a user may select the appropriate tire from a list of tires in order to associate the tires of the vehicle with their predetermined calibration curves. In other examples, some tires may include a data storage device with a unique identifier, such as a radio-frequency (RF) tag, that in turn identifies the calibration curves associated with the tire such that the control module may select the appropriate calibration curve without user input. In some examples, the control module may use the identification of the tires to retrieve the one or more calibration curves modeling weight versus pressure for the tires of the vehicle from a remote data storage device based on the identification of the tires. The remote data storage device may be located in control module 116 or elsewhere in vehicle 110 or in mobile communication device 120.

In other examples, the control module may download calibration curves modeling weight versus pressure for the tires of the vehicle from a remote data storage device via a long-range wireless connection, such as a cellular connection. In yet further examples, the control module may instruct the user to load and/or unload the vehicle in a prescribed manner such that the control module may determine the calibration curve of each of the tires of the vehicle.

In some examples, the control module may interact with a user via a user interface, as discussed above. The user interface may simplify the determination of the calibration curve of each of the tires of the vehicle. For example, the user interface may provide a selectable menu or box to receive a user input of the tires of the vehicle. In another example, the user interface may facilitate automated calibration. The user interface may include a button allowing the user to initiate a calibration procedure, in which the control module takes an initial tire pressure of each of the tires. The user interface may then issue instructions for the user to load or unload a known weight of cargo from the vehicle. Once the user has loaded or unloaded the cargo, the user interface may receive a user input indicating the completion of the loading or unloading of the cargo. In some examples, the user interface may further receive indications of the weight of the cargo loaded or unloaded during the calibration procedure and/or the location of the cargo loaded or unloaded during the calibration procedure. The control module may use this information to build calibration curves for the tires of the vehicle.

In another example, the user interface may simplify the determination of the weight or the change in weight of the vehicle. For example, the user interface may provide a selectable menu or box to receive a user input of the tires of the vehicle. The user interface may include a button allowing the user to initiate a change in weight measurement procedure, in which the control module takes an initial tire pressure of each of the tires. The user interface may then issue instructions for the user to load or unload the cargo from the vehicle. Once the user has loaded or unloaded the cargo, the user interface may receive a user input indicating the completion of the loading or unloading of the cargo. The control module may then retest the tire pressure of each of the tires and use this information in combination with the initial tire pressures to determine the change in weight of the vehicle. In some examples, the control module may also use tire temperature information associated with one, two or all the tires, during the initial testing and the retest to determine the change in weight of the vehicle. In some examples, the change in weight of the vehicle may be combined with a predetermined total weight of the vehicle during the initial testing to determine the weight of the vehicle after the loading or unloading. In other examples, the tires pressure may directly correspond to a weight of a vehicle according to the calibration curves of the tires.

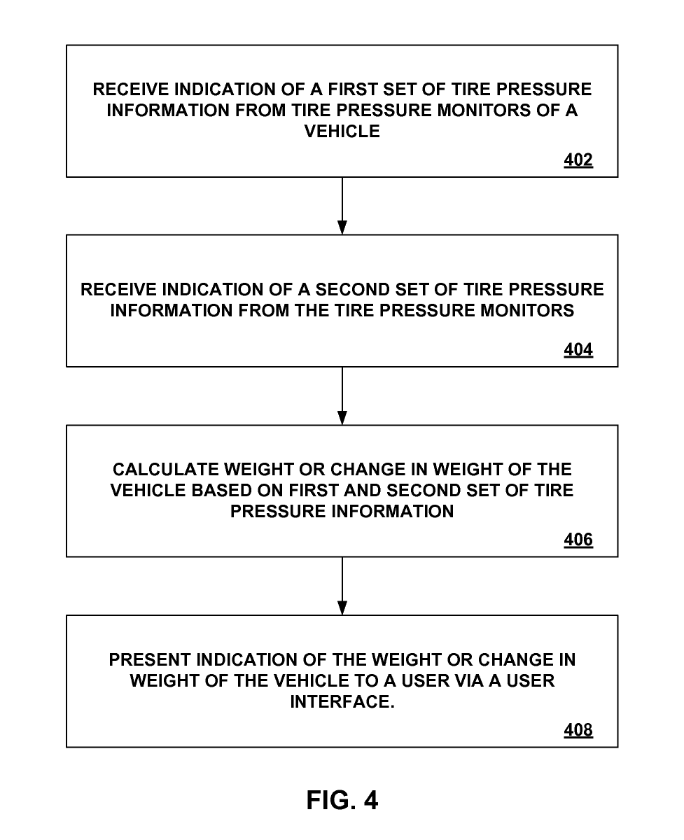

FIG. 4 is a flowchart illustrating example techniques for determining a weight of a vehicle based in detected tire pressures in the tires of the vehicle. For clarity, the techniques of FIG. 4 are described with respect to system 100, including vehicle 110 of FIG. 1.

The control module, which may be control module 116, mobile communication device 120, another electronic device, or a combination thereof, receives an indication of a first set of tire pressure information from one or more of tire pressure sensors 114 (402). Then the control module receives an indication of a second set of tire pressure information from one or more of tire pressure sensors 114 (404). In some examples, the control module may receive an instruction from an operator to store the first set of tire pressure information, which may occur prior to loading or unloading cargo from vehicle 110. The control module may then receive another instruction from an operator to store the second set of tire pressure information after the loading or unloading cargo from vehicle 110.

Then the control module calculates a weight of vehicle 110 or a change in weight of vehicle 110 based on the first set of tire pressure information and the second set of tire pressure information (406). The control module presents an indication of the weight of vehicle 110 or the change in weight of vehicle 110 to a user via user interface. In different examples, the user interface may be part of vehicle 110, part of mobile communication device 120 or part of a different electronic device.

### EXAMPLE

Assume the weight of an empty vehicle is known prior to loading of cargo. Then the control module stores tire pressure information from each of the tire pressure sensors. An operator loads the cargo in the vehicle, and the control module stores tire pressure information from each of the tire pressure sensors. The control module may then determine the change in pressure for each of the tires and, based on the calibration curves associated for each of the tires, convert each of the changes in pressure to a change in load on that tire. The change in weight of the vehicle may be calculated by summing the change in load for each of the tires of the vehicle.

In a real life example, assuming a tire pressure of 2 bar (=200 kPa) and an accuracy of 30 mbar (=3 kPa) of an individual tire pressure sensor, additional loads can be calculated in increments of 15 kg (based on a m₀=1000 kg weight of the vehicle). However, this load is distributed onto typically 4 wheels, so that the detection accuracy would reduce to 60 kg. This is still a reasonable value: A maximum typically allowed additional weight Δm of a small car (Pkw) is approx. 300-500 kg. Pressure sensors having increased precision would allow even greater accuracy.

Techniques described in this disclosure may provide one or more benefits or advantages. As one example, using tire pressure information to calculate a weight or a change in weight of the vehicle provides a low-cost and elegant way for operators to determine the weight of cargo. For example, may vehicles already include tire pressure sensors. Likewise, preexisting computing components, such as onboard processor of a vehicle and/or a processor of a mobile communication device may be programmed as a control module that calculates a weight or a change in weight of the vehicle based on the tire pressure information. In some examples, the disclosed techniques may provide a suitable alternative for scale weighing, which may save time and money related to use a scale suitable for a vehicle, as well as prevent potential unsafe driving conditions in that the load of a vehicle is not known after loading cargo and before measurement at a scales.

The techniques described in this disclosure may be implemented, at least in part, in hardware, software, firmware, or any combination thereof. For example, various aspects of the described techniques, including the disclosed transmission control systems, may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “control system,” “controller” or “control module” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a transitory or non-transitory computer-readable storage medium, containing instructions. Instructions embedded or encoded in a computer-readable medium, including a computer-readable storage medium, may cause one or more programmable processors, or other processors, such one or more processors included in a control system, to implement one or more of the techniques described herein, such as when instructions included or encoded in the computer-readable medium are executed by the one or more processors. Non-transitory computer-readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer-readable media. In some examples, an article of manufacture may comprise one or more computer-readable storage media.

Various examples of this disclosure have been described. Modification of the described examples may be made within the spirit of this disclosure. These and other examples are within the scope of the following claims.

What is claimed is:

1. A system comprising:
a set of tire pressure sensors for tires of a vehicle;
a control module configured to receive tire pressure information from the tire pressure sensors, and calculate a weight or a change in weight of the vehicle based on the tire pressure information; and
a user interface configured to present, to a user, an indication of the weight or the change in weight of the vehicle calculated by the control module.

2. The system of claim 1, wherein the control module stores a record of the change in weight of the vehicle over time on a computer readable medium.

3. The system of claim 1,
wherein the control module is located within the vehicle, and
wherein the control module is powered by an electrical system of the vehicle.

4. The system of claim 1, wherein the control module is located outside the vehicle.

5. The system of claim 1, wherein the control module is a mobile communication device.

6. The system of claim 1,
wherein the control module receives the tire pressure information from the tire pressure sensors via at least one wireless data connection,
wherein the tire pressure sensors each include a wireless transmitter for sending the tire pressure information to the control module, and
wherein the control module includes a wireless receiver for receiving the tire pressure information from the tire pressure sensors.

7. The system of claim 1, wherein the set of tire pressure sensors includes at least one tire pressure sensor uniquely associated within each of the tires of the vehicle.

8. The system of claim 1,
wherein the control module is further configured to calculate a load balance based on the tire pressure information, and
wherein user interface is further configured to present an indication of the load balance calculated by the control module.

9. The system of claim 1, wherein calculating the weight or the change in weight of the vehicle based on the tire pressure information includes:
accessing an indication of one or more calibration curves modeling weight versus pressure for the tires of the vehicle; and
calculating the weight or the change in weight of the vehicle based on the tire pressure information and further based on the indication of one or more calibration curves.

10. The system of claim 9, further comprising at least one thermometer that outputs at least one temperature associated with the tires of the vehicle,
wherein the calibration curves further model the weight versus pressure and temperature for the tires of the vehicle, and
wherein calculating the weight or the change in weight of the vehicle based on the tire pressure information includes calculating the weight or the change in weight of the vehicle based on the tire pressure information, on the temperature associated with the tires of the vehicle, and further based on the indication of one or more calibration curves.

11. The system of claim 1, further comprising at least one data storage device that stores information that identifies the one or more calibration curves modeling weight versus pressure for the tires of the vehicle.

12. The system of claim 11, wherein the at least one storage device is located in one or more of the tires.

13. The system of claim 12,
wherein the data storage device stores an identification of the tire, and
wherein the control module is configured to retrieve the one or more calibration curves modeling weight versus pressure for the tires of the vehicle from a remote data storage device based on the identification of the tire.

14. The system of claim 11, wherein the data storage device stores the one or more calibration curves modeling weight versus pressure for the tires of the vehicle.

15. The system of claim 1, further comprising:
the vehicle; and
the tires, wherein the tires are mounted to the vehicle and the tire pressure sensors are mounted to the tires.

16. The system of claim 15, wherein the vehicle is selected from a group consisting of:
a passenger car;
a sport utility vehicle;
a van;
an agricultural vehicle; and
a trailer.

17. A method comprising:
receiving, with a control module, an indication of a first set of tire pressure information from one or more tire pressure sensors of a vehicle;
receiving, with the control module, an indication of a second set of tire pressure information from the one or more tire pressure sensors of the vehicle;
calculating, with the control module, a weight of the vehicle or a change in weight of the vehicle based on the first set of tire pressure information and the second set of tire pressure information; and
presenting, with the control module, an indication of the weight of the vehicle or the change in weight of the vehicle to a user via user interface.

18. The method of claim 17, wherein calculating the weight or the change in weight of the vehicle based on the tire pressure information includes:
accessing, with the control module, an indication of one or more calibration curves modeling weight versus pressure for the tires of the vehicle; and
calculating, with the control module, the weight or the change in weight of the vehicle based on the tire pressure based on the tire pressure information and further based on the indication of one or more calibration curves.

19. The method of claim 18, further comprising determining, with the control module, the identity of one or more tires of the vehicle based on at least one storage device is located in one or more of the tires,
wherein accessing the indication of one or more calibration curves modeling weight versus pressure for the tires of the vehicle includes selecting, with the control module, the calibration curves based on the identity of one or more tires of the vehicle.

20. The method of claim 18, the method further comprising receiving an indication of a temperature of the tires,
wherein the calibration curves further model the weight versus pressure and temperature for the tires of the vehicle, and
wherein calculating the weight or the change in weight of the vehicle based on the tire pressure information includes calculating, with the control module, the weight or the change in weight of the vehicle based on the tire pressure based on the tire pressure information, on the temperature associated with the tires of the vehicle, and further based on the indication of one or more calibration curves.
